(19) United States
(12) Patent Application Publication
(10) Pub. No.: US 2017/0090484 A1
(43) Pub. Date: Mar. 30, 2017

(54) DRONE-BASED PERSONAL DELIVERY SYSTEM

(71) Applicant: T-Mobile U.S.A., Inc., Bellevue, WA (US)

(72) Inventor: Ahmad Arash Obaidi, Mercer Island, WA (US)

(21) Appl. No.: 14/869,922

(22) Filed: Sep. 29, 2015

(51) Int. Cl. G05D 1/10; B64D 9/00; H04W 4/00; G06Q 10/08; G06Q 30/00; B64C 39/02; B64D 47/08

(52) U.S. Cl. CPC G05D 1/104; B64C 39/024; B64D 9/00; B64D 47/08; G06Q 10/0835; G06Q 30/0185; H04W 4/008; B64C 2201/128; H04W 84/042

(57) ABSTRACT

Drone-based package delivery infrastructure includes, e.g. a registration system, a mobile application for requesting the delivery drones, multi-factor authentication subsystems (e.g., biometric readers and cameras on the drones), a scheduling coordinator, and a management portal. For example, a delivery drone can be requested via a mobile application. The scheduling coordinator can identify a drone and route it to the pick-up location. Upon nearing the pick-up destination, the drone can turn on a camera and stream the data to a monitoring platform to help identify the person submitting the cargo or anyone who might damage the drone. In addition, once the drone lands, additional authentications may be required to aid in identifying the user. The package may be analyzed for harmful/illegal content. The management portal allows for remote requests for the drones to land for inspection (e.g., by the police or border agents).

### BACKGROUND

There are a variety of options for delivering packages from one location to another. These options can range from large parcel delivery services to personalized courier services. The large parcel delivery services, such as postal systems and private parcel services, can deliver packages anywhere around the world. These large parcel delivery services often provide package pick-up and drop-off using drop boxes at fixed locations or personal package pick-up along regular routes. In contrast to these larger parcel delivery services, courier services (e.g., bike couriers) are often available in many cities, and can provide very quick personalized pick-up and delivery within smaller geographic regions. While limited in delivery range, courier services can often be significantly faster (e.g., less than an hour) and more personal.

While large parcel delivery services can automate much of the sorting and tracking of large volumes of packages, they remain dependent on a significant amount of human interaction for the delivery and pick-up. Courier services depend even more on human involvement from pick-up through delivery with often no automation. While traditionally necessary, this extensive use of human involvement has a lot of disadvantages. For example, in addition to maintaining different types of vehicles (e.g., trucks, airplanes, etc.), there is a significant cost in benefits and wages for employees of the delivery service. In addition, some employees may mishandle (e.g., steal, roughly handle, etc.) the packages. Another example of a disadvantage is the limited pick-up and delivery times (e.g., no Sunday deliveries) for many services. And, many of these delivery options are often at the mercy of traffic congestion, construction causing street closures, and other logistic issues facing certain locations such as urban locations. These are only some problems that exist. It is with respect to these and other problems that embodiments of the present invention have been made.

### BRIEF DESCRIPTION OF THE DRAWINGS

Embodiments of the present technology will be described and explained through the use of the accompanying drawings in which:

FIG. 1 illustrates an example of an environment in which some embodiments of the present technology may be utilized;

FIG. 2 illustrates a delivery drone landing at a pick-up/drop-off point according to one or more embodiments of the present technology;

FIG. 3 illustrates a delivery drone at a recharging station in accordance with various embodiments of the present technology;

FIG. 4 illustrates a set of components within a delivery drone according to various embodiments of the present technology;

FIG. 5 illustrates a set of components within a mobile device with a drone management application according to various embodiments of the present technology;

FIG. 6 illustrates a set of components of a drone management engine used for scheduling and monitoring delivery drones according to various embodiments of the present technology;

FIG. 7 is a flowchart illustrating a set of operations for scheduling a delivery drone in accordance with some embodiments of the present technology;

FIG. 8 is flowchart illustrating a set of operations for modifying a delivery drone flight plan in accordance with one or more embodiments of the present technology; and

FIG. 9 is an example of a graphical user interface that may be used in accordance with some embodiments of the present technology.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Systems and methods for package delivery are described in detail herein. Various embodiments address different aspects of the infrastructure needed for a delivery drone fleet (e.g., an autonomous unmanned aerial vehicle) capable of personalized pick-up and delivery of a variety of items. The infrastructure, according to various embodiments, can include a registration system, a mobile application for requesting delivery drones, multi-factor authentication subsystems (e.g., biometric readers and cameras on the delivery drones), a scheduling coordinator, and a management portal. This infrastructure allows an individual to request a customized pick-up and drop-off of a variety of items.

For example, once a user registers with a registration system, the user can request a delivery drone via a mobile application available through a wireless service provider (e.g., T-Mobile). The scheduling coordinator can identify a delivery drone that meets the necessary requirements for the pick-up and delivery (e.g., battery power, range, availability, size, weight constraints, etc.) The wireless service can be used to send the identified delivery drone instructions for picking up the package or item. Upon nearing the pick-up destination, the delivery drone can turn on a camera and stream the data back to a monitoring platform to help identify the person submitting the cargo or anyone who might damage the delivery drone or be injured by the drone. In addition, once the delivery drone lands, additional authentications may be required (e.g., fingerprint scans, voice recordings, etc.) to aid in identifying the user. The package may also be analyzed to ensure that harmful/illegal content is not added. The management portal allows for management of the drones including an option for a request for the drones to land for inspection by the police or border agents.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to delivery drones, embodiments of the present technology are equally applicable to customized scheduling and management of drones and other autonomous vehicles for any purpose (e.g., autonomous cabs). In addition, the types of drones utilized by some embodiments are not limited to aerial vehicles but instead relate to any vehicle capable of air, sea, or land based transit. For example, delivery drones may include water-based drones that ride on top of or under water.

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

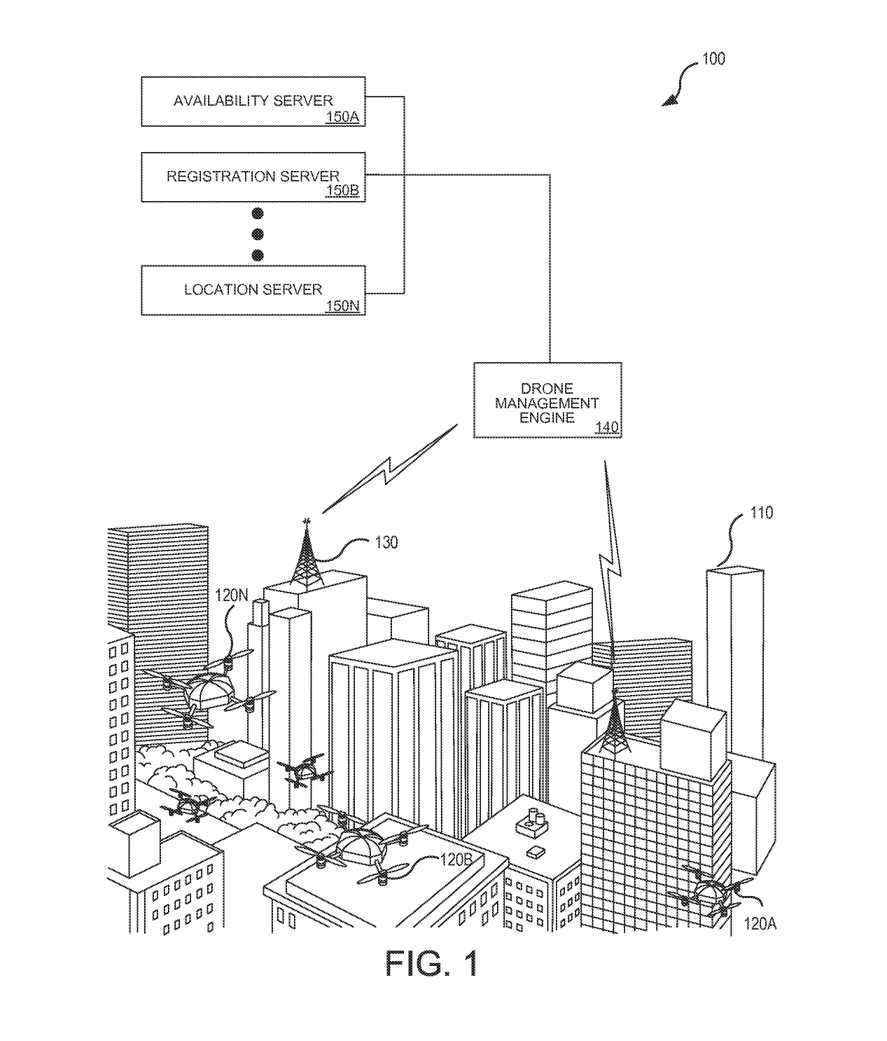

FIG. 1 illustrates an example of an environment 100 in which some embodiments of the present technology may be utilized. As illustrated in FIG. 1, environment 100 shows a geographical region (e.g., a city or metro area) 110 that has multiple delivery drones 120A-120N (such as a quadcopter or other autonomous aircraft), communications network 130, drone management engine 140, and a variety of remote servers 150A-150N. In accordance with various embodiments, delivery drones 120A-120N can include network communication components that enable the delivery drones to communicate with drone management engine 140, remote servers 150A-150N or other portable electronic devices (not shown) by transmitting and receiving wireless signals using licensed, semi-licensed or unlicensed spectra over communications network 130.

In some cases, communication network 130 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. Communications network 130 can also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), or Long Term Evolution (LTE) network), or other communications network.

Those skilled in the art will appreciate that various other components (not shown) may be included in delivery drones 120A-120N to enable network communication. For example, a delivery drone may be configured to communicate over a GSM or newer mobile telecommunications network. As a result, the delivery drone 120A-120N may include a Subscriber Identity Module (SIM) card that stores an International Mobile Subscriber Identity (IMSI) number that is used to identify the delivery drones 120A-120N on the GSM mobile or other communications networks, for example, those employing 3G and/or 4G wireless protocols. One advantage of this type of configuration is that the delivery drone can be equipped with one or more cellular radios to permit direct communication with users, e.g. sending a text when the drone approaches a departure or arrival location. If delivery drone 120A-120N is configured to communicate over another communications network, the delivery drone 120A-120N may include other components that enable it to be identified on the other communications networks.

In some embodiments, delivery drones 120A-120N may include components that enable them to connect to a communications network using Generic Access Network (GAN), Unlicensed Mobile Access (UMA), or LTE-U standards and protocols. For example, delivery drones 120A-120N may include components that support Internet Protocol (IP)-based communication over a Wireless Local Area Network (WLAN) and components that enable communication with the telecommunications network over the IP-based WLAN. Further, while not shown, the delivery drones 120A-120N may include capabilities for permitting communications with satellites. Delivery drones 120A-120N may include one or more mobile applications that need to transfer data or check-in with drone management engine 140 and/or remote servers 150A-150N.

Remote servers 150A-150N can include a variety of servers that collect and manage a variety of information. As illustrated in FIG. 1, these remote servers can include an availability server 150A, a registration server 150B, and a location server 150N. Drone management engine 140 may submit a query to availability server 150A to determine which delivery drones 120A-120N are available for completing a delivery within a specified time window. The results of the query may then be used by drone management engine 140 for the coordination and scheduling of a package pick-up and delivery. For example, drone management engine 140 may select drones based on location, timing availability, maximum speed, range, cargo capabilities (e.g., size, weight, etc.), cost of operation, and/or other factors (e.g., weather conditions, landing areas, etc.).

Availability server 150A may include a variety of entries for each drone that identify the drone, tracks the current status (e.g., power, location, busy, etc.), drone capabilities (e.g., maximum package weight, flight speed, maximum distance, maximum flight time, etc.), future scheduled deliveries, past completed deliveries, and the like. The following table is an example of a few entries that may be stored within availability server 150A:

| ID | Status | Max Weight | | Max Speed | Future Deliveries |
|---|---|---|---|---|---|
| 0001 | (24%, IR, B) | 10 | Pounds | 15 MPH | 1A74B |
| 0002 | (U, U, M) | 20 | Pounds | 30 MPH | None |
| 0003 | (72%, CS8, A) | 5 | Pounds | 17 MPH | None |

As illustrated in this table, each drone may be assigned a unique identifier. In some embodiments, a portion of the identifier may represent the drone's model or capabilities. A variety of codes can indicate the status. For example, “IR” may indicate in-route, “B” may indicate busy, “CS8” may indicate charging station eight, “A” may indicate available, or “U” may indicate unknown. Of course, other codes and status elements may be used in accordance with embodiments of the present invention.

Registration server 150B can be designed to register users (e.g., via a graphical user interface) of the delivery system. Once a user is registered, the user may then access the system to schedule customized deliveries. Location server 150N may be used to store the current and past locations of each delivery drone 120A-120N within the drone delivery fleet. While not illustrated, the system may connect to other servers for items such as, but not limited to, weather forecasts, geographical reports, flight restrictions, etc., and thereby actively modify drone availability, drone routes, etc. based on data from these other servers. In accordance with some embodiments, the delivery drones can be operated automatically using a GPS navigation system that's built on-board to provide updated navigation route. The GPS system can calculate the optimum route or routes that are preprogrammed between major cities/destinations. The GPS system and other components of the delivery drones could also be updated remotely using Firmware-Over-The-Air.

While not illustrated in FIG. 1, some embodiments allow for the delivery system to be an integral part of a marketplace as part of a value added service. In accordance with some embodiments, a user buying or selling an item may select drone-based delivery. Once a transaction is completed, the marketplace may interface with the delivery system to automatically schedule a pick-up and drop-off with the seller and buyer.

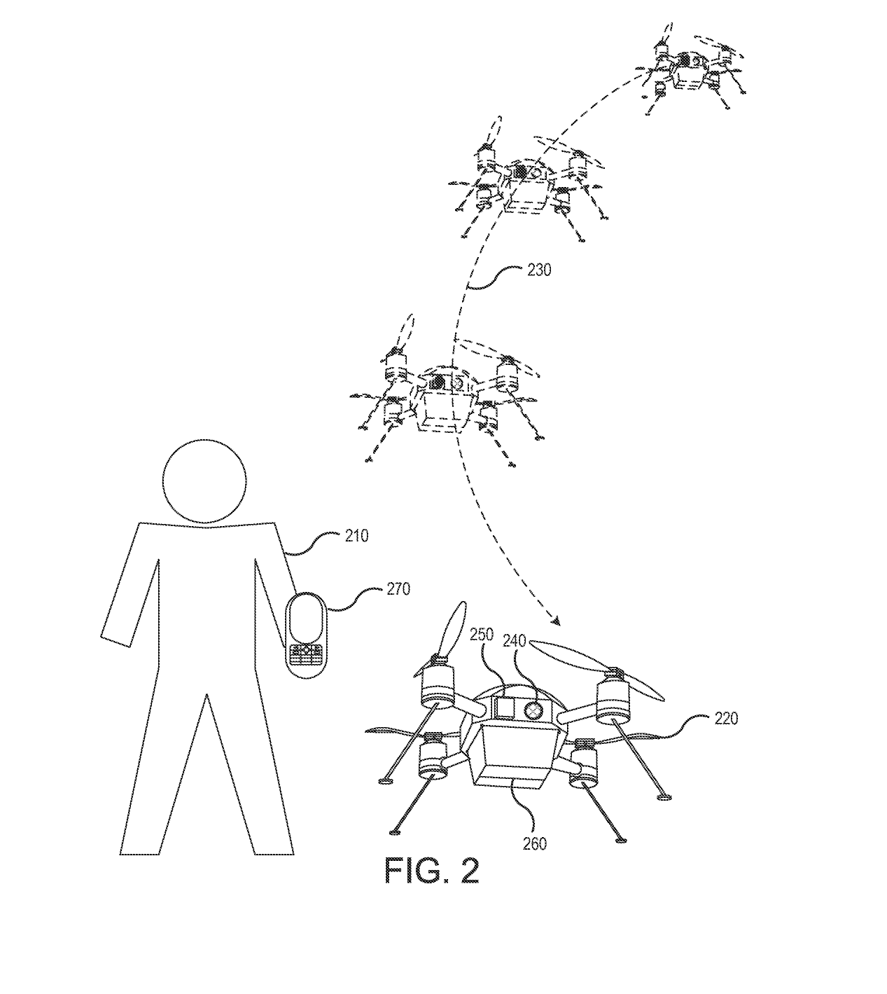

FIG. 2 illustrates a delivery drone landing at a pick-up/drop-off point according to one or more embodiments of the present technology. Once a user 210 schedules a pick-up at a desired location, the scheduling system identifies a suitable drone (e.g., based on battery power, availability, weight constraints, operational costs, and/or other factors) and directs selected delivery drone 220 to the location for package pick-up. Delivery drone 220 follows the flight path 230 and lands near user 210. Upon nearing the pick-up destination, delivery drone 220 can activate camera 240 and stream the data (e.g., via a cellular network) back to a monitoring platform. This information can be used in a variety of ways including to help identify the person 210 submitting the cargo or anyone who might damage delivery drone 220.

In some embodiments, once delivery drone 220 lands, additional authentications may be required (e.g., fingerprint scans, voice recordings, etc.) using sensors 250 before user 210 can access cargo bay 260. This information can be used in identifying or authenticating the user. The package may also be analyzed with a variety of sensors to ensure that harmful/illegal content is not being added. For example, a non-destructive inspection process may be used to determine whether any explosive material is contained within the contents being added to cargo bay 260. Cargo bay 260 may be interchangeable. As such, delivery drone 220 may arrive with or without cargo bay 260 as indicated in a delivery request. Interchangeable cargo bays may allow a user to pre-pack the item or allow for authorized inspections of the cargo to ensure no unauthorized content is added to the cargo bay. In some embodiments, once the cargo bay can be sealed after passing inspection to ensure no unauthorized content is included. This feature also allows for quick drop-offs as the delivery drone does not have to wait for removal of the content. In other embodiments, cargo bay 260 is securely affixed and may include a variety of mechanisms (e.g., trap doors, conveyor belts, etc.) for dislodging contents that do not pass an automated inspection process initiated by the delivery drone.

In accordance with various embodiments, user 210 may have a mobile device 270 to communicate with delivery drone 220. For example, delivery drone 220 may use signals from mobile device 270 to hone in on the user's location. Delivery drone 220 may send various notifications (e.g., updates on arrival time) via a cellular or personal area network to delivery drone 220. In some embodiments, various biometric sensors (e.g., fingerprint reader, camera, microphone, etc.), software (e.g., voice analysis software, or other hardware or software security feature may be used to ensure the package is delivered to right person. For example, some embodiments may use nearfield communications or a Bluetooth connection to transfer security data to the right recipient.

In accordance with some embodiments, the network of delivery drones may be partially or completely assigned to a single cellular network. Such a feature would allow the drone delivery system to leverage the security of the cellular network. For example, this may help prevent hackers gaining access to the network of drones and redirecting one or more of the delivery drones. In some embodiments, only subscribers to a particular cellular network may be allowed to request drones.

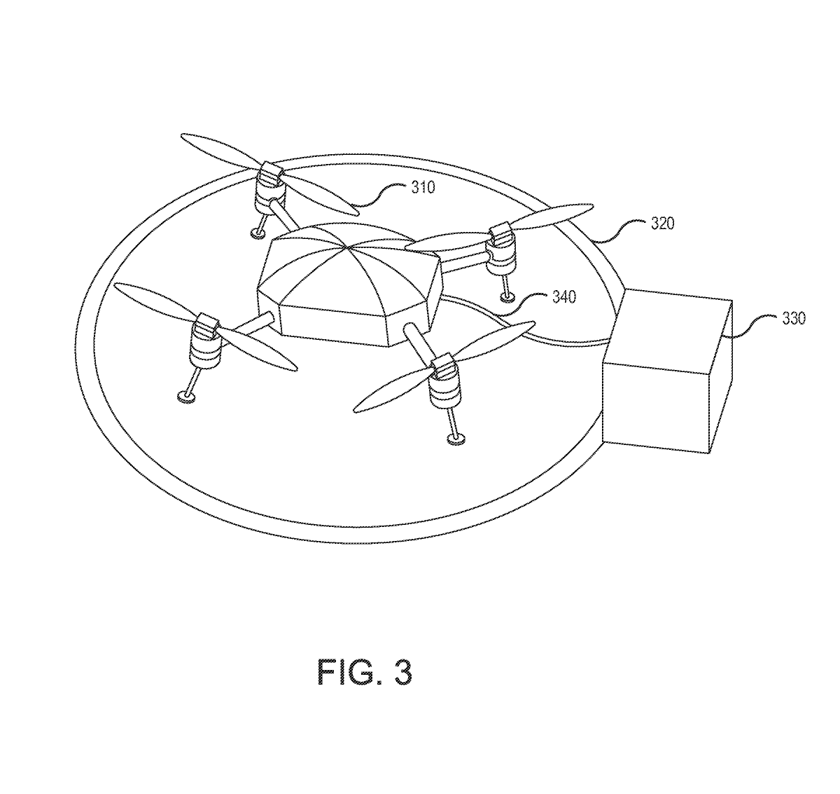

FIG. 3 illustrates delivery drone 310 at recharging station 320 in accordance with various embodiments of the present technology. Recharging station 320 may include one or more power supplies 330 capable of connecting to delivery drone 310 via conduit 340 to allow for charging of batteries, firmware updates, instructions transfer, and the like. The conduit 340 may have a coupler (not shown) that permits the drone to automatically land and connect to the conduit and receive power, data or both. Recharging stations may be located in multiple locations to allow for recharging during deliveries so as to either effectively extend the range of delivery drone 310 or allow more flexibility in pick-up times as the drone will not have to be sufficiently charged before starting the delivery. For example, recharging stations 320 may be environmentally ruggedized and placed on easily accessible rooftop locations. Further, such stations can include beacons or other means to allow drones to easily identify and accurately connect with them.

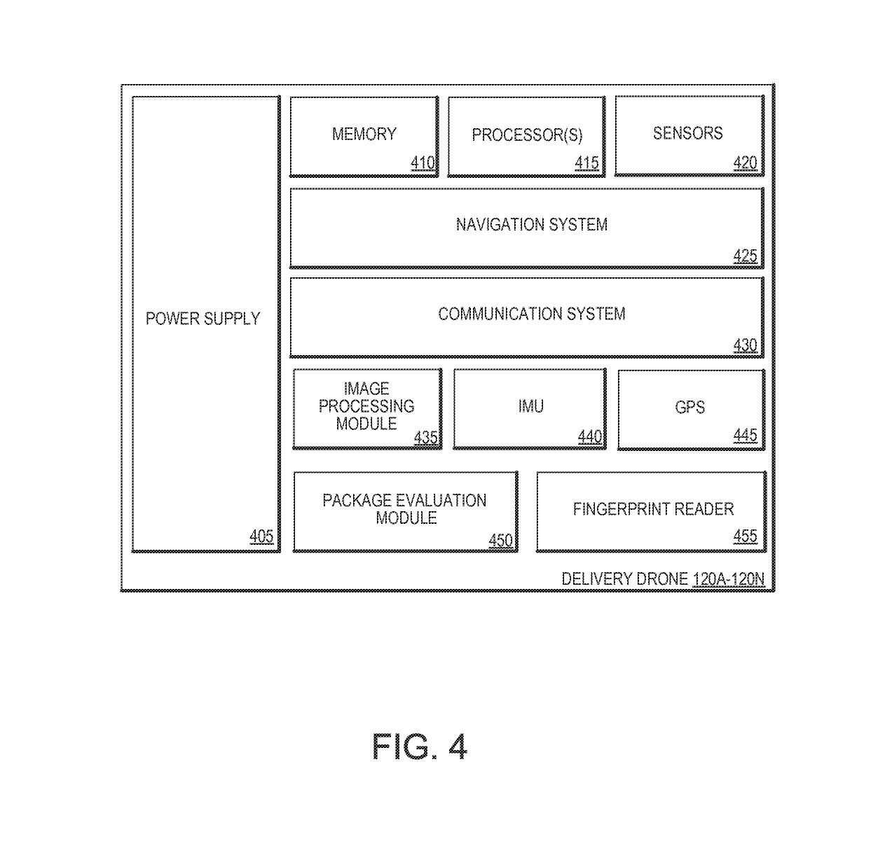

FIG. 4 illustrates a set of components within delivery drone 120A-12N according to various embodiments of the present technology. As shown in FIG. 4, delivery drone 120A-120N may include power supply 405 (e.g., battery), memory 410 (e.g., volatile memory and/or nonvolatile memory), processor(s) 415 for executing instructions and performing calculations, sensors 420, navigation system 425, communication system 430, image processing module 435, inertial measurement unit (IMU) 440, global positioning system (GPS) 445, package evaluation module 450, and fingerprint reader 455.

Processor(s) 415 are the main processors of delivery drone 120A-120N which may include application processors, various coprocessors, and other dedicated processors for operating delivery drone 120A-120N. Processor(s) 415 may be communicably coupled with memory 410 and configured to run the operating system, user interfaces, sensors 420, navigation system 425, communication system 430, image processing module 435, and/or other components. In some embodiments, processor(s) 415 may include multiple dedicated or shared processors configured to perform signal processing (e.g. baseband processors for cellular communications), implement/manage real-time radio transmission operations, of delivery drone 120A-120N, make navigation decisions (e.g., compute flight paths, implement obstacle avoidance routines, etc.). These processors along with the other components may be powered by power supply 405. The volatile and nonvolatile memories found in various embodiments may include storage media for storing information such as processor-readable instructions, data structures, program modules, or other data. Some examples of information that may be stored include basic input/output systems (BIOS), operating systems, and applications.

Sensors 420 may be used to detect events or changes in the surrounding environment and produce a corresponding signal that can be acted upon by various components within the delivery drone or transmitted to other parts of the drone delivery infrastructure. In some embodiments, sensors 420 may include one or more of the following: a microphone, a camera, a thermostat, an accelerometer, light sensors, motion sensors, moisture sensors, fingerprint readers, retinal scanners, chemical sensors, scales, LIDAR, RADAR, and the like. Several of these sensors, for example, may be used as part of navigation system 425. Other sensors may be used to evaluate the package or record the environment. As another example, battery life can vary significantly based on temperature. As such, the temperature reading from the thermostat may be used to more accurately predict the range of the delivery drone. In some embodiments, the signal generated by the microphone can be used to determine the noise level of the surrounding environment and to record a voice message or identification from a user inserting or removing a package. Still yet, sensors 420 may include credit card readers for accepting payments, including Bluetooth or near field communication (NFC) systems.

Navigation system 425 can be responsible for determining the flight path of delivery drone 120A-120N. In some embodiments, high-level instructions or pick-up/drop-off destinations can be communicated to the drone via communication system 430. Navigation system 425 may receive inputs from multiple sensors 420 (e.g., accelerometers, gyroscopes, LIDAR, RADAR, etc.), image processing module 435, IMU 440, and/or GPS 445 to determine optimal flight paths, detect and avoid objects, coordinate with other nearby drones using communication system 430, and the like. For example, IMU 440 can determine the delivery drone's orientation and velocity.

Package evaluation module 450 can use input from sensors 420, image processing module 435, and/or fingerprint reader 455 to determine whether to accept the package from the user. For example, package evaluation module 450 may request user authentication via fingerprint reader 455 and/or another biometric reader. If the reading does not match the record on file (e.g., from an initial registration with the delivery system), then the package evaluation module 450 may determine to not accept the package. As another example, a scale may be used to measure the weight of the package. If package evaluation module 450 determines that the package exceeds a maximum weight for the delivery drone, then the package may be denied.

Package evaluation module 450 may use multiple different types of sensors 420 to make a determination. For example, package evaluation module 450 may use the image processing module 435 to identify the size and/or type of package, various types of chemical sensors to detect possible explosives, barcode readers to identify an originator/packer, as well as others. In some embodiments, the package analysis governed by package evaluation module 450 could be a combination of: X-Ray of packages and/or chemical sensors to ensure hazardous packages are not sent. In some embodiments, the delivery drones may also include a display (e.g., a liquid crystal display) or interface with a mobile device (e.g., via a personal area network, Bluetooth, cellular network, etc.) to confirm with the user that no hazardous packages (e.g., listed on the display) are included in the shipment. If no confirmation is received, the package evaluation module 450 may refuse the delivery.

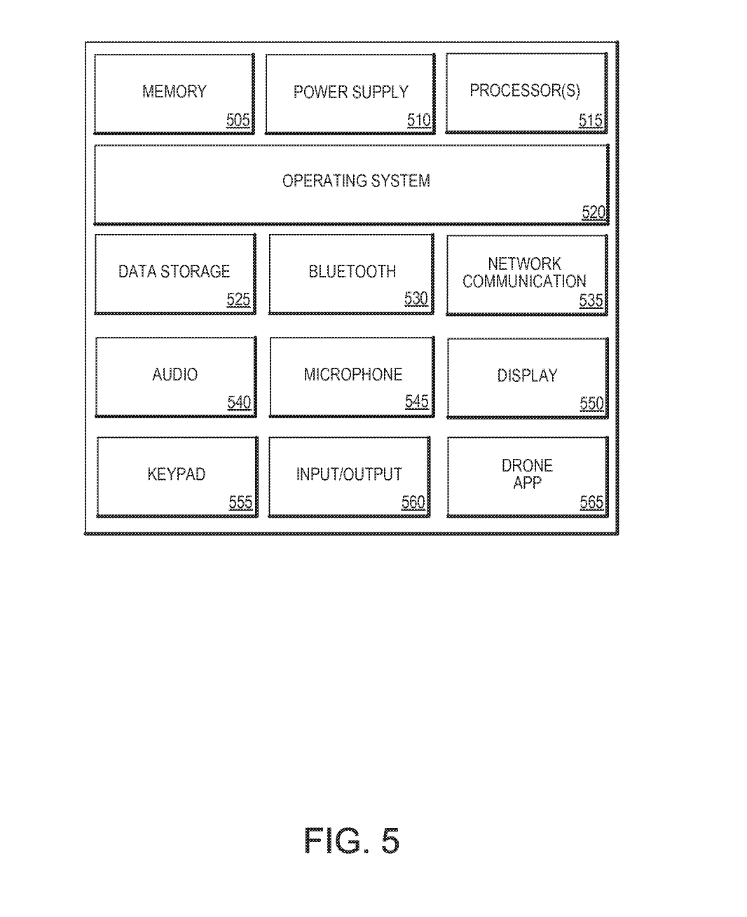

FIG. 5 illustrates a set of components within a mobile device with a drone management application according to various embodiments of the present technology. As shown in FIG. 5, mobile device 500 may include memory 505 (e.g., volatile memory and/or nonvolatile memory), power supply 510 (e.g., battery), processor(s) 515 for executing processing instructions, and operating system 520. Additional components such as data storage component 525 (e.g., hard drive, flash memory, memory card, etc.), one or more network interfaces (e.g., Bluetooth Interface 530; and Network Communication Interface 535, which enables the mobile phone to communicate by transmitting and receiving wireless signals using licensed, semi-licensed or unlicensed spectra over a telecommunications network), audio interface 540, microphone 545, display 550, keypad or keyboard 555, and other input and/or output interfaces 560 (e.g. a fingerprint reader or other biometric sensor/security feature). The various components of a mobile device may be interconnected via a bus.

Processor(s) 515 are the main processors of mobile device 500, and they may include application processors, baseband processors, various coprocessors, and other dedicated processors for operating mobile device 500. For example, an application processor can provide the processing power to support software applications, memory management, graphics processing, and multimedia. An application processor may be communicably coupled with memory 505 and configured to run the operating system, the user interface, and the applications stored on memory 505 or data storage component 525. A baseband processor may be configured to perform signal processing and implement/manage real-time radio transmission operations of mobile device 500. These processors along with the other components may be powered by power supply 510. The volatile and nonvolatile memories found in various embodiments may include storage media for storing information such as processor-readable instructions, data structures, program modules, or other data. Some examples of information that may be stored include basic input/output systems (BIOS), operating systems, and applications.

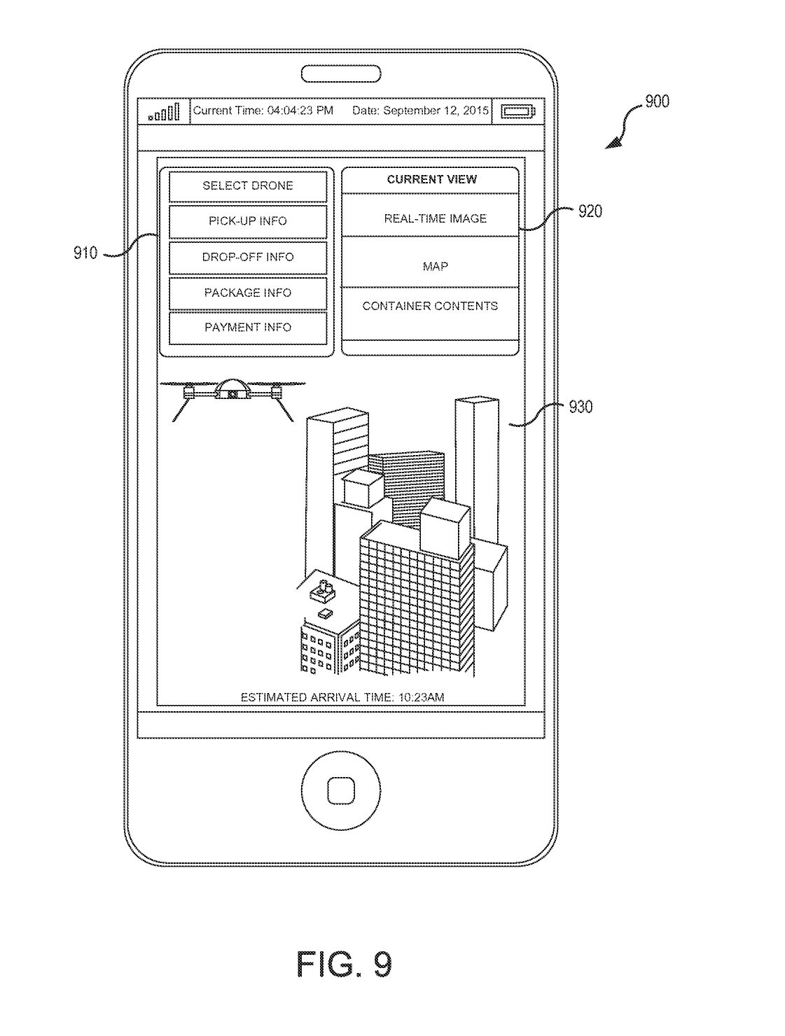

In accordance with some embodiments, drone application 565 may be installed on mobile device 500. Drone application 565 may be used to register a user, confirm pick-up/drop-off locations and/or times, convey the current location of a delivery drone, provide real-time video or images from a delivery done, reschedule pick-up/drop-off times/locations, and the like. An example of an interface generated by drone application 565 is illustrated in FIG. 9 below.

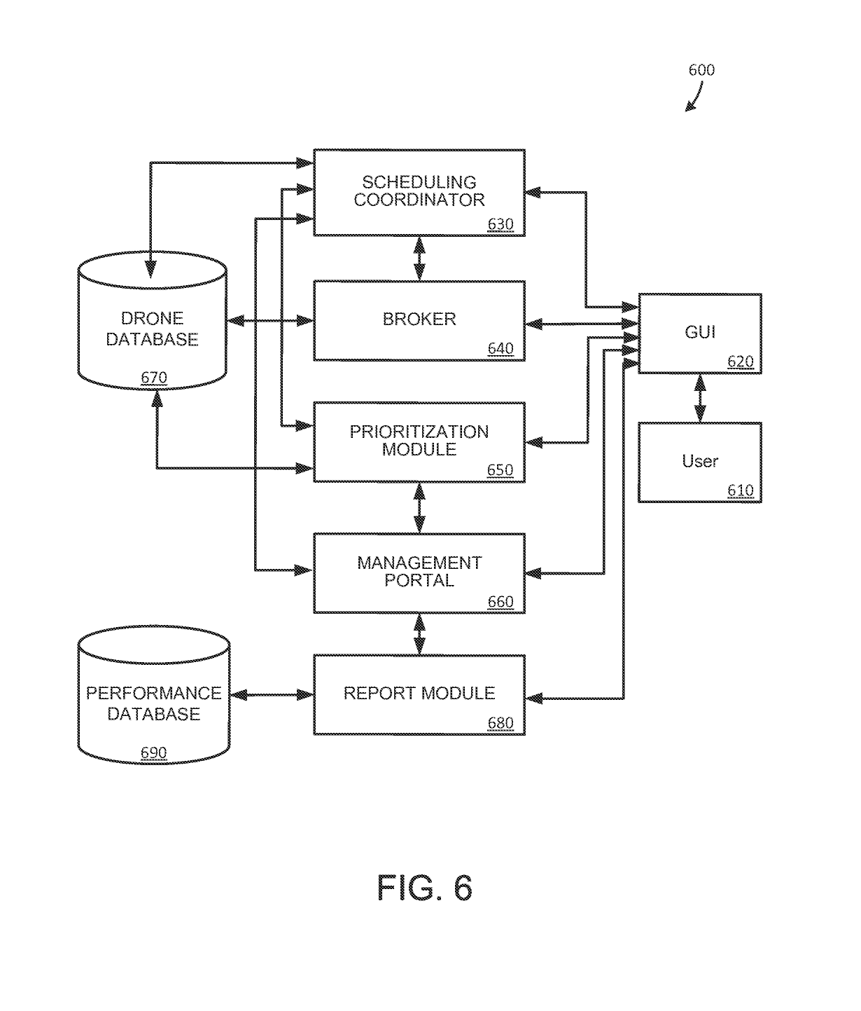

FIG. 6 illustrates a set of components 600 of a drone management engine 140 used for scheduling and monitoring delivery drones according to various embodiments of the present technology. As illustrated in FIG. 6, drone management engine 140 allows user 610 to interface with GUI 620 to request a drone pick-up. GUI 620 (e.g., generated via mobile app 565) can then transmit the request to scheduling coordinator 630. Scheduling coordinator 630 is responsible for efficiently scheduling the delivery drone. Scheduling coordinator 630 may base selection of the delivery drone from the fleet based on current drone locations, package information, user preferences, battery power, weather conditions, and/or other preference or constraint.

In some cases, scheduling coordinator 630 may need to request the services of broker 640 or prioritization module 650 to determine which drones should be allocated to which request. For example, in some embodiments, the drones may be owned and operated by multiple different operators. As such, broker 640 can take bids for the current job request. The bids can be received through various automated auctions (e.g., reverse auction, Dutch auction, blind auction, etc.) In other cases, preferred providers may be offered a right of first refusal on a fixed price. Still yet, in some embodiments, scheduling coordinator 630 may provide a small set of drones determined to be a good fit for the delivery request. Once these are received, broker 640 can determine which drone to use based on bidding, next in queue, and the like. Using these and other techniques, broker 640 can identify to scheduling coordinator 630 a delivery drone that can complete the delivery. Once selected, scheduling coordinator 630 can use various communications (e.g., wireless networks) to convey the instructions to the selected delivery drone.

When multiple requests are received, scheduling coordinator 630 may use prioritization module 650 to determine a priority for completing the requests. Prioritization module 650 can use factors such as, but not limited to, user priorities, current wait times, drone locations, and the like. In some cases, one or more governmental agencies or regulators can issue requests for one or more drones to deviate from their delivery schedule. For example, when a drone is schedule to cross country borders, a request for deviation to comply with customs inspections may be processed using management portal 660.

As another example, firefighter or police agencies may set up temporary or permanent no-fly zones. Still yet, police may request that a delivery drone land for execution of a search warrant or other reasons. In some embodiments, the drone delivery system may use features of the communications network to prioritize or enhance communications. For example, the drone delivery system may use the E911 system in a cellular network to effectively deliver needed supplies to first responders with the delivery drones. Examples of supplies may include drugs (e.g. anti-venom), neutralizing agent (e.g., to Haz-Mat team), water, clothes, tools, and the like. All of these requests are handed through management portal 660.

Drone database 670 logs the current status of each drone. In addition, some drones provide streaming video or images of selected (e.g., pick-up and drop-off) parts of their flight. These media may be stored in drone database 670. In addition, drone management engine 140 may include report module 680 for generating reports based on performance data logged in performance database 690.

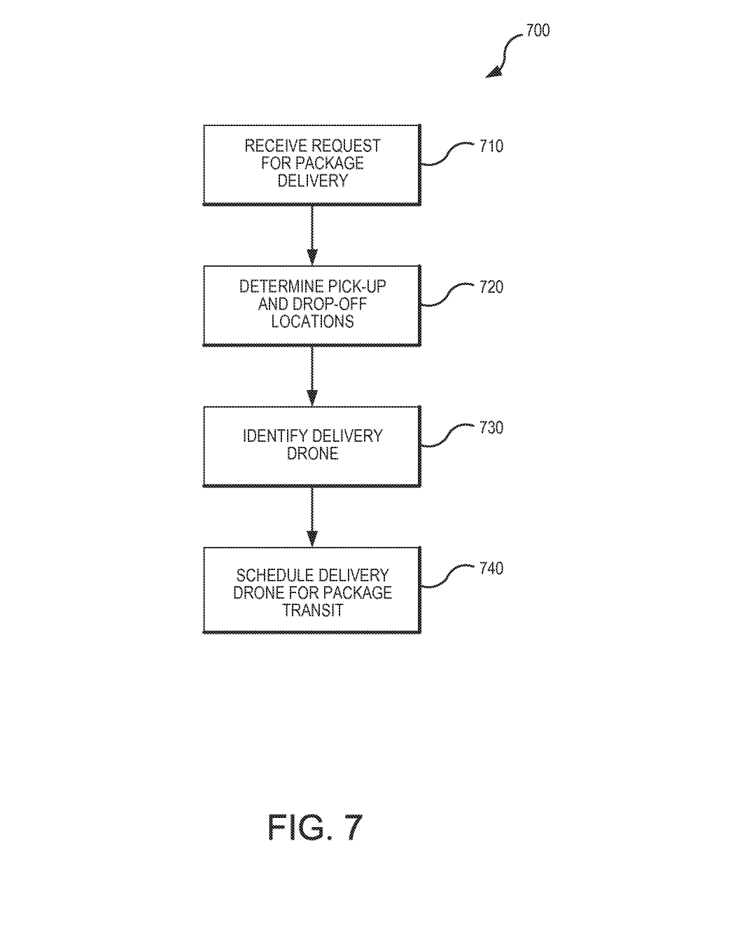

FIG. 7 is a flowchart illustrating a set of operations 700 for scheduling a delivery drone in accordance with some embodiments of the present technology. As illustrated in FIG. 7, a request for package delivery is received during receiving operation 710. The request may include a variety of information such as user/account identifiers, pick-up/drop-off locations, desired time windows, information about the package being delivered, and the like. During determination operation 720, pick-up and drop-off locations are determined. This may be accomplished, for example, by parsing the request for package delivery, accessing real-time mobile device information, accessing pre-set pick-up/drop-off locations from a user account, and the like.

Using information about the pick-up/drop-off locations, identification operation 730 can identify a delivery drone and using scheduling operation 740 to schedule the delivery drone for package transit. As discussed above, identification operation 730 can use additional information to identify a drone. Examples include, but are not limited to, drone location, timing availability, maximum speed, cargo capabilities (e.g., size, weight, etc.), cost of operation, and/or other factors (e.g., weather conditions, landing areas, etc.).

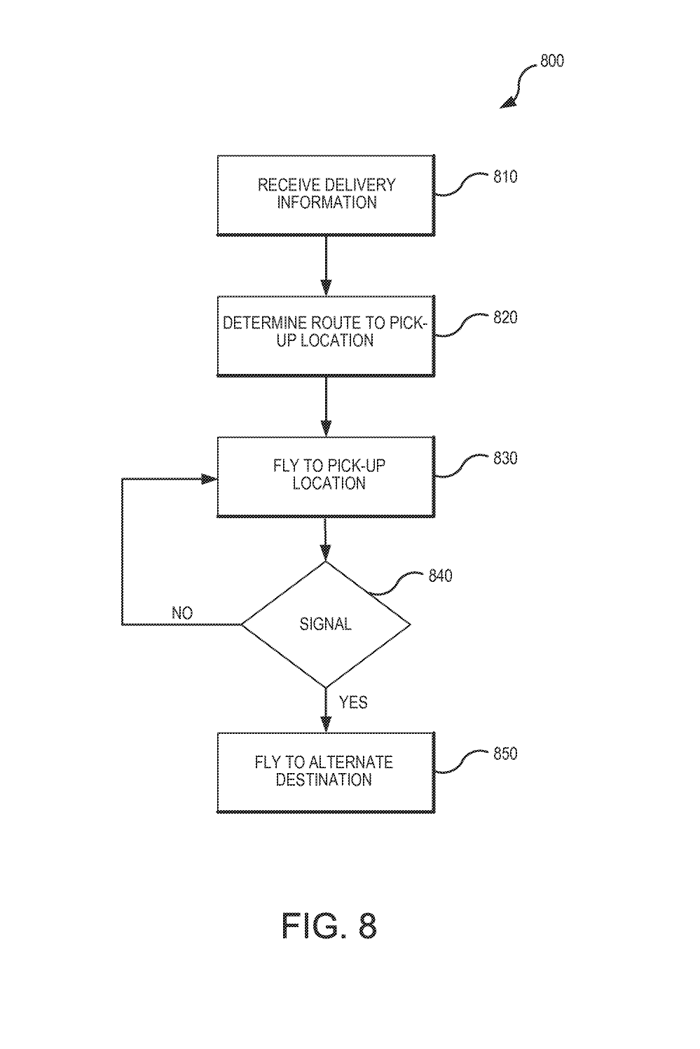

FIG. 8 is flowchart illustrating a set of operations 800 for modifying a delivery drone flight plan in accordance with one or more embodiments of the present technology. In the embodiments illustrated in FIG. 8, delivery information is received at a delivery drone during receiving operation 810. The delivery information may be received, for example, via a cellular communication or other wireless network. This information can be used to determine a nominal route to the pick-up location from the delivery drone's current location during operation 820. During pick-up operation 830, the delivery drone navigates the nominal path to the pick-up location.

During this time, the delivery drone may using monitoring operation 840 to monitor for additional, potentially out-of-band, signals indicating the delivery drone should alter course. When no signal is detected during monitoring operation 840, monitoring operation branches to pick-up operation 830 allowing the delivery drone to continue to the pick-up destination. When a signal is detected, monitoring operation 840 branches to alternate operation 850 which instructs the delivery drone to fly to an alternate location. For example, automated beacons may be setup near country borders or along known drug routes to have the drones land for inspection.

FIG. 9 is an example of a graphical user interface 900 that may be used in accordance with some embodiments of the present technology. Graphical user interface 900 may allow a user to select a drone, set pick-up/drop-off information, set package information, and set payment information through window 910. Once drone management engine 140 selects a delivery drone, the user can select various views (e.g., real-time image stream, locations on maps, images/video of container content, etc.) through window 920. As illustrated in 930, the GUI may display the current view selected by the user (e.g., an image or video from the drone).

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in each specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. §112(f) will begin with the words “means for”, but use of the term “for” in any other context is not intended to invoke treatment under 35 U.S.C. §112(f). Accordingly, the applicant reserves the right to pursue additional claims after filing this application to pursue such additional claim forms, in either this application or in a continuing application.

What is claimed is:

1. A method for operating a drone management engine, the method comprising:
receiving, at the drone management engine, a delivery request to deliver a package to a user or to a destination,
wherein the delivery request includes package pick-up and drop-off information;
identifying, upon receipt of the delivery request, a delivery drone from a fleet of multiple delivery drones to which to assign the delivery request,
wherein at least two of the delivery drones have different capabilities; and
wherein identifying the delivery drone from the fleet of multiple delivery drones is based at least in part on the different capabilities;
transmitting, via a cellular telecommunications network, instructions to the delivery drone assigned the delivery request; and
monitoring the delivery drone during execution of the delivery request.

2. The method of claim 1, wherein the fleet of multiple delivery drones includes at least two different drone operators each operating a subset of the fleet and wherein identifying the delivery drone includes creating a reverse auction allowing the two operators to bid on the delivery request.

3. The method of claim 1, wherein monitoring the delivery drone includes receiving streaming video recorded from the delivery drone.

4. The method of claim 1, further comprising:
receiving, at the drone management engine, a command signal requesting the delivery drone be rerouted to a new location;
verifying the drone should be rerouted; and
transmitting instructions, via the cellular telecommunications network, requesting the drone reroute to the new location.

5. The method of claim 1, further comprising:
gathering drone information from one or more databases,
wherein the drone information includes current location, expected range, cost of operation, and maximum cargo weight; and
wherein identifying the delivery drone from the fleet of multiple delivery drones to which to assign the delivery request is based at least in part on the drone information; and
determining a number of recharging stops needed by the delivery drone to complete the delivery request.

6. The method of claim 1, further comprising:
receiving, from the delivery drone, biometric information gathered during the package pick-up or drop-off,
wherein the biometric information is gathered via an application running on a mobile device;
verifying, at the drone management engine, the biometric information; and
sending instructions, via the cellular telecommunications network, back to the delivery drone to accept or leave the package during the package pick-up or drop-off based on the results of the verifying.

7. The method of claim 1, further comprising:
receiving, from the delivery drone, biometric information gathered during the package pick-up or drop-off,
wherein the biometric information is gathered via sensors integrated into the delivery drone;
verifying, at the drone management engine, the biometric information; and
sending instructions, via the cellular telecommunications network, back to the delivery drone to accept or leave the package during the package pick-up or drop-off based on the results of the verifying.

8. A delivery drone comprising:
a processor;
a wireless transceiver coupled to the processor,
wherein instructions for the delivery drone can be received from a drone management engine via the wireless transceiver; and
wherein the instructions include a delivery request with at least a pick-up location and identifying information about a subscriber that will be loading an item for transport;
a memory, coupled to the processor, to store the delivery request upon receipt from the drone management engine;
a validation module, under the control of the processor, to validate the identity of the subscriber; and
a cargo compartment to accept the item from the subscriber upon successful validation by the validation module.

9. The delivery drone of claim 8, further comprising one more of a fingerprint reader, a camera, or a microphone to collect information about the subscriber for use by the validation module.

10. The delivery drone of claim 8, further comprising a camera and wherein the delivery drone will activate the camera upon approach to the pick-up location and stream video back to the drone management engine.

11. The delivery drone of claim 8, wherein the wireless transceiver uses a personal area network, nearfield communications, or Bluetooth to communicate with an application running on a mobile device, and wherein the application and mobile device are used to gather identifying information of the subscriber.

12. The delivery drone of claim 8, further comprising a camera and the memory containing instructions to:
activate the camera to record an image or video of the item upon entry into the cargo compartment; and
transmit the image or video of the item to a mobile device.

13. The delivery drone of claim 8, further comprising:
one or more sensors to collect information about the item,
wherein the one or more sensors include a camera, a chemical sensor, or a scale; and
a package evaluation module to receive the information collected by the sensors and determine whether to accept the item for delivery.

14. The delivery drone of claim 8, further comprising:
one or more sensors to collect information about the item; and
a package evaluation module to receive the information collected by the sensors and determine whether to accept the item for delivery.

15. The delivery drone of claim 8, wherein the cargo compartment can be removed from the delivery drone.

16. A computer-readable medium, excluding transitory signals, storing instructions that when executed by one or more processors cause a machine to:
receive multiple delivery requests to delivery items from one location to another using delivery drones,
wherein each of the delivery requests include package pick-up and drop-off information;
assign delivery drones from a fleet of multiple delivery drones to each of the delivery requests,
wherein each delivery drone is assigned based at least in part on locations and availability of the multiple delivery drones; and
transmit instructions to each of the delivery drones assigned delivery requests.

17. The computer-readable medium of claim 16, wherein the instructions when executed by the one or more processors further cause the machine to prioritize the multiple delivery requests based on subscriber levels or the package pick-up and drop-off information.

18. The computer-readable medium of claim 16, wherein the instructions when executed by the one or more processors further cause the machine to:
automatically generate a dynamic cost estimate for each of the delivery requests,
wherein the dynamic cost estimate is based at least in part on the locations and availability of the multiple delivery drones;
transmit the cost estimate for each of the delivery requests back to applications running on mobile devices used to generate each of the delivery requests; and
receive a confirmation that a subscriber agrees to the cost estimate for a particular delivery request before assigning delivery drones to complete that particular delivery request.

19. The computer-readable medium of claim 16, wherein the instructions when executed by the one or more processors further cause the machine to:
receive a command signal requesting a first delivery drone be rerouted to a new location;
verify the first delivery drone should be rerouted; and
transmit additional instructions requesting the first delivery drone reroute to the new location.

20. The computer-readable medium of claim 16, wherein the instructions when executed by the one or more processors further cause the machine to:
receive biometric information gathered during the package pick-up or drop-off,
verify the biometric information; and
send instructions back to the delivery drone to accept or leave the package during the package pick-up or drop-off based on the results of the verifying.
